(19) United States
(12) Patent Application Publication
(10) Pub. No.: US 2026/0238123 A1
(43) Pub. Date: Aug. 13, 2026

(54) CHARGE PUMP WITH ADAPTIVE PERIOD SHIFTING

(71) Applicant: Renesas Electronics America Inc., Milpitas, CA (US)

(72) Inventor: Eric Magne SOLIE, Durham, NC (US)

(73) Assignee: Renesas Electronics America Inc., Milpitas, CA (US)

(21) Appl. No.: 19/052,584

(22) Filed: Feb. 13, 2025

(51) Int. Cl. H02M 3/07; H02M 1/00

(52) U.S. Cl. CPC H02M 3/07; H02M 1/0025

(57) ABSTRACT

Systems and methods for implementing a charge pump with adaptive period shifting is generally described. The method can include sensing an output voltage from a charge pump. The output voltage is equal to a steady state voltage level of the charge pump. The method can further include, based on the sensed output voltage, determining whether the output voltage is within a voltage window centered around an input voltage or outside of the voltage window. The method can further include adjusting a period of a clock signal based on the determination of whether the output voltage is within or outside the voltage window. The clock signal drives the charge pump.

### BACKGROUND

The present disclosure relates in general to semiconductor devices. More specifically, the present disclosure relates to a charge pump with non-dissipating output voltage sensing.

A charge pump power converter is a type of DC-DC converter that can convert an input voltage to a desired output voltage without using inductors. Instead, it relies on capacitors as energy storage elements and switches to control the charge transfer process. The charge pump typically includes a controller, switches, and capacitors. The controller provides control signals (such as clock signals) to the switches, which alternately connect capacitors in series or parallel configurations. This alternate switching enables the capacitors to transfer and store charge, effectively boosting or inverting the input voltage to produce the desired output voltage.

### SUMMARY

In one embodiment, a semiconductor device that can implement adaptive period shifting is generally described. The semiconductor device can include a voltage sense circuit configured to sense an output voltage from a charge pump. The output voltage can be equal to a steady state voltage level of the charge pump. The semiconductor device can further include a circuit configured to output a signal that indicates whether the sensed output voltage is within a voltage window centered around an input voltage or outside of the voltage window. The semiconductor device can further include a controller configured to adjust a period of a clock signal based on the signal output by the circuit. The clock signal can drive the charge pump.

In one embodiment, a system that can implement adaptive period shifting is generally described. The system can include a charge pump configured to convert an input voltage into an output voltage equal to a steady state level of the charge pump. The system can further include a controller configured to generate a clock signal to drive the charge pump. The system can further include a circuit configured to sense the output voltage being outputted by the charge pump. The circuit can, based on the sensed output voltage, determine whether the output voltage is within a voltage window centered around the input voltage or outside of the voltage window. The circuit can further adjust a period of the clock signal based on the determination of whether the output voltage is within the voltage window or outside of the voltage window.

In one embodiment, a method that can implement adaptive period shifting is generally described. The method can include sensing an output voltage from a charge pump. The output voltage is equal to a steady state voltage level of the charge pump. The method can further include, based on the sensed output voltage, determining whether the output voltage is within a voltage window centered around an input voltage or outside of the voltage window. The method can further include adjusting a period of a clock signal based on the determination of whether the output voltage is within or outside the voltage window. The clock signal drives the charge pump.

### BRIEF DESCRIPTION OF THE DRAWINGS

FIG. 1 is a diagram showing a system that can implement a charge pump with adaptive period shifting in one embodiment.

FIG. 2 is a diagram showing an implementation of a charge pump with adaptive period shifting in another embodiment. FIG. 4 is another diagram showing

[symbol]

FIG. 3 is a diagram showing waveforms of the implementation of a charge pump with adaptive period shifting in another embodiment

[symbol]

FIG. 4 is a flow chart illustrating a process to implement a charge pump with adaptive period shifting in an example embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

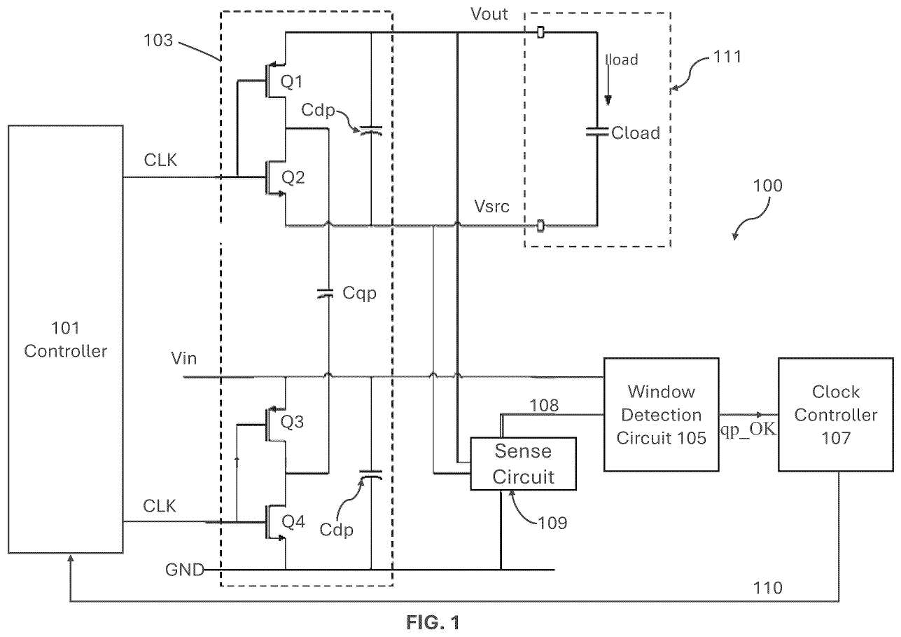

FIG. 1 is a diagram showing a system that can implement a charge pump with adaptive period shifting in one embodiment. A system 100 shown in FIG. 1 can be implemented by one or more semiconductor devices. System 100 can include at least a controller 101, a charge pump power converter circuit 103 (hereinafter “charge pump 103”), a window detection circuit 105, a clock controller 107, voltage sense circuit 109, and a load 111.

Controller 101 can be, for example, a processor, microcontroller, central processing unit (CPU), field-programmable gate array (FPGA), a state machine, or any other circuitry that is configured to control and operate system 100. While described as a state machine in illustrative embodiments, controller 101 is not limited to a state machine in these embodiments and may comprise any other circuitry that is configured to control and operate charge pump 103, window detection circuit 105 and/or clock controller 107. Controller 101 can be configured to generate clock signals CLK for controlling charge pump 103 and can be configured to receive control signals 110 output by the clock controller 107. To be described in more detail below, controller 101 can be configured to adjust the clock period based on the control signals 110.

Charge pump 103 can be, for example, a single-phase charge pump comprising of four switching elements Q1, Q2, Q3, and Q4 (hereinafter “switches Q”) in a half-bridge circuit configuration. The charge pump 103 can also be a multi-phase charge pump in another embodiment. The charge pump 103 can comprise of a high-side HS and a low-side LS, wherein the high-side can comprise of switching elements Q1 and Q2 and low-side LS can comprise of switching elements Q3 and Q4. Switches Q can be, for example, field-effect transistors (FETs) such as metal oxide semiconductor field effect transistors (MOSFETs). Charge pump 103 can be configured to switch the switches Q ON and OFF using clock signals CLK to convert an input voltage Vin into a voltage to be output at voltage output pin Vout (or output voltage Vout) to load 111. Load 111 can be, for example but not limited to, a capacitive load C_{load}. During operation, the output voltage Vout of the charge pump 103 can provide a load current I_{load} to the capacitve load C_{load}.

Charge pump 103 can include a decoupling capacitors Cdp. A decoupling capacitor Cdp can be connected in parallel with switches Q1 and Q2, and a second decoupling capacitor Cdp can be connected in parallel with switches Q3 and Q4. The decoupling capacitors Cdp can suppress or filter unwanted noise in the charge pump 103. Further, charge pump 103 can include a flying capacitor Cqp that can be connected in between the HS switches Q1, Q2 and the LS switches Q3, Q4.

Voltage sense circuit 109 can be a circuit comprising electrical components configured to measure or monitor the voltage and/or current at a specific point in a system and provide this information to other components for control, monitoring, or protection purposes. For example, the voltage sense circuit 109 can be configured to use sense resistors or a configuration with non-dissipative voltage sensing. Voltage sense circuit 109 can be configured to perform non-dissipative voltage sensing by sensing and sampling voltage 108, which can be used for determining output voltage Vout−Vsrc. The sampled voltage 108 can be provided to a window detection circuit for comparison. In the example embodiment as seen in FIG. 1, voltage sense circuit 109 is configured to sense the voltage difference between Vout and Vsrc, therefore, the sampled voltage 108 is equal to Vout−Vsrc. Voltage sense circuit 109 can also be configured to sense the voltage difference between Vout, Vsrc, therefore, sampled voltage 108 can be equal to Vout−Vsrc.

Controller 101 can be configured to provide clock signals CLK to the corresponding switches in the charge pump 103. The controller 101 can generate clock signals CLK to control the switches Q. Because the high-side HS switches Q1 and Q2 operate in a higher voltage domain, a level-shifted version of the clock signals CLK is provided. Thus, low-side LS switches Q3, Q4 are controlled based on clock signals CLK and switches Q1 and Q2 are controlled based on level-shifted clock signals CLK. For example, when the clock signals CLK are HIGH, switch Q3 can turn OFF, and Q4 can turn ON, allowing the bottom of pump capacitor Cqp to charge from Vin. Simultaneously, the level-shifted clock signals CLK cause switch Q1 to turn OFF and Q2 ON, allowing the flying capacitor Qqp to charge from Vsrc. Conversely, when the clock signals CLK are LOW, switch Q3 turns ON and switch Q4 turns OFF, and the level-shifted clock signals CLK cause switch Q1 to turn ON and switch Q2 to turn OFF, allowing the charge stored in flying capacitor Cqp to transfer to Vout and the load 111.

When the controller 101 initiates a clock signal CLK, the charge pump 103 provides a load current I_{load} to the load 111. The voltage across the load 111 will increase until it reaches a steady state voltage level of the charge pump 103. This steady state voltage level between Vout and Vsrc can be, for example, equal to the input voltage Vin or a predetermined voltage level depending on the application of the system 100. The maximum output current that the charge pump 103 can provide is inversely proportional to the period of the clock signal CLK. Therefore, increasing the clock frequency reduces the clock period, allowing the charge pump 103 to transfer charge more frequently and deliver a higher maximum current to the load 111. Conversely, a lower clock frequency results in a longer clock period, reducing the rate at which charge is transferred and thereby lowering the maximum output current. This relationship introduces a trade-off between the clock period and the bias current of the charge pump 103, which includes losses due to internal dissipation within the charge pump. Typically, a fast rise time of the output voltage Vout−Vsrc is desirable, such as for the quick turn-on of a transistor or a rapid rise time of a data signal. However, a higher clock period results in a slower rise time of the output voltage, which can degrade system performance. On the other hand, while setting a low clock period provides a faster rise time of output voltage Vout−Vsrc, the bias current of the charge pump 103 does not decrease even after the output voltage has reached the steady-state voltage level of the charge pump 103. As a result, running the charge pump 103 at a higher clock frequency allows for higher output current but also leads to a consistently higher bias current throughout the operating range.

System 100 comprises a window detection circuit 105 configured to define an output voltage window. This window includes a threshold set above the charge pump steady-state voltage and a threshold set below the desired output voltage. Voltage sense circuit 109 is configured to sense the output voltage Vout−Vsrc cycle by cycle or after skipping several clock cycles, and provide the sampled voltage 108 to the window detection circuit 105. The window detection circuit 105 determines whether the sampled voltage 108 falls within the defined window and sends this information to the clock controller 107.

When the charge pump 103 is initially enabled, the clock signal CLK is set to its minimum period to rapidly raise the output voltage. Cycle by cycle of the clock signal CLK or after skipping many clock cycles, as the output voltage approaches the steady-state voltage level, the sampled voltage 108 is compared against the thresholds of the voltage window. If the output voltage Vout−Vsrc falls within the window, the clock controller 107 provides a control signal 110 to the controller 101 to increase the period of the clock signal CLK. This adjustment reduces the bias current of the charge pump 103 while maintaining the steady-state voltage of the charge pump 103. The feedback loop operates cycle by cycle or after skipping many clock cycles, ensuring that the clock period of clock signal CLK dynamically adapts to the output voltage to optimize system performance.

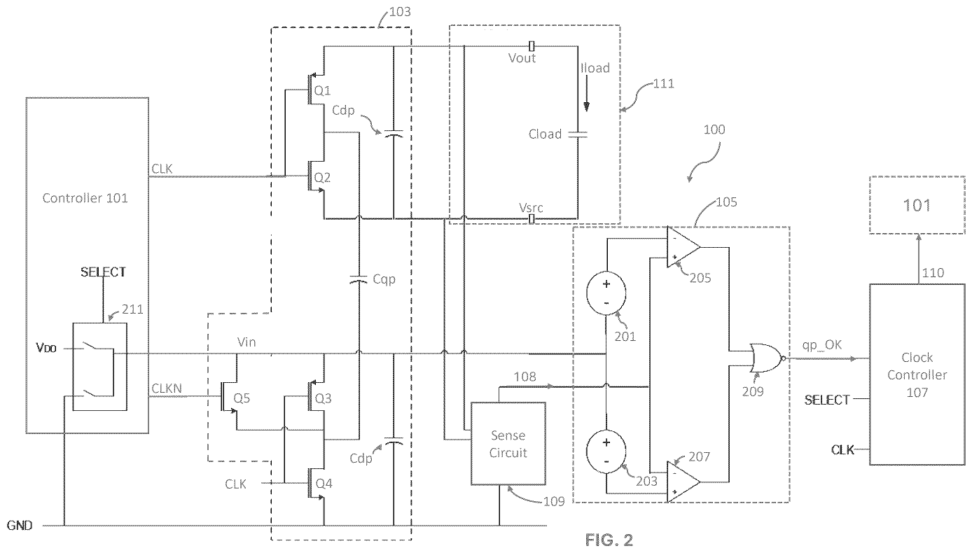

FIG. 2 is a diagram showing an implementation of a charge pump with adaptive period shifting in another embodiment. Descriptions of FIG. 2 may reference components shown in FIG. 1. In the example embodiment shown in FIG. 2, charge pump 103 can include a switch Q5 to be in parallel with LS switch Q3. Charge pump 103 can also be configured to switch the switch Q5 ON and OFF using inverted clock signals CLKN. The inverted clock signals CLKN can be the logical complement of clock signals CLK, i.e., the rising edge of the clock signals CLK become the falling edge of the inverted clock signals CLKN.

[symbol] controller 101 can comprise of a switch 211, which may be implemented as a transistor, such as an NMOS or PMOS transistor. Utilizing switch 211, controller 101 can operate charge pump 103 in multiple modes. A signal SELECT can be generated by controller 101 in synchronization with the clock signal CLK to enable or disable the operation of charge pump 103 and the various operation modes. In one example embodiment, switch 211 is configured to switch between two modes. When the signal SELECT enables the operation of charge pump 103, switch 211 can be configured to connect the voltage V_{DD} at the drain terminal of the switch 211 to the input voltage node Vin, supplying a voltage V_{DD} to the input of the charge pump. With Vin equal to V_{DD}, the charge pump 103 can be configured to increase the output voltage Vout−Vsrc. Further, SELECT signal can control switch 211 to disconnect V_{DD} from Vin and establish a connection between Vin and ground GND. With Vin equal to ground GND, the charge pump 103 can be configured to decrease the output voltage Vout−Vsrc.

When the operation of the charge pump 103 begins, voltage sense circuit 109 can sense and sample the output voltage Vout−Vsrc every clock cycle or after skipping many clocks. The sampled voltage 108 is provided to window detection circuit 105, which processes the voltage to determine whether Vout−Vsrc is within the acceptable range. Window detection circuit 105 can include electrical components such as comparators 205 and 207, an OR gate 209, and voltage supplies 201 and 203. These components can be configured to define a voltage window centered around the input voltage Vin. Voltage supply 201 is configured to provide an upper bound for the voltage window, greater than Vin, while voltage supply 203 provides a lower bound, less than Vin. The voltage window is predetermined and adjustable, depending on the specific application of the charge pump. The upper and lower bounds do not need to be equally bounded around Vin. For example, the upper bound may be 1% greater than the steady-state voltage of charge pump 103 and the lower bound maybe 5% lower than the steady state voltage of charge pump 103. In another example embodiment, the lower bound voltage could be 70 mV and the upper bound voltage could be 540 mV. In an example embodiment where the steady state voltage is equal to ground GND, the upper bound voltage could be greater than ground GND and the lower bound voltage could be less than ground GND.

Comparator 205 can be configured to receive the upper bound voltage from voltage supply 201 at its inverting input and the sampled voltage 108 at its non-inverting input. This configuration enables comparator 205 to generate a signal indicating whether the sampled voltage 108 is below the upper bound of the voltage window. Comparator 207 can be configured to receive the lower bound voltage from voltage supply 203 at its non-inverting input and the sampled voltage 108 at its inverting input. This configuration allows comparator 207 to generate a signal indicating whether the sampled voltage 108 is above the lower bound of the voltage window. The outputs of comparators 205 and 207 are fed into an NOR gate 209. The NOR gate compares these outputs and generates a signal indicating whether the sampled voltage 108 is outside the defined voltage window. If the sampled voltage is greater than the upper bound (detected by comparator 205), or less than the lower bound (detected by comparator 207), the NOR gate outputs a signal qp_OK as a logic LOW signal (or binary 0 signal), indicating the voltage is out of range. If neither condition is true, meaning the sampled voltage is within the bounds of the voltage window, the NOR gate outputs signal qp_OK as a logic HIGH signal (or binary 1 signal).

The signal qp_OK output by the window detection circuit 105 can be received by clock controller 107. The clock controller 107 is configured to output a control signal 110 based on signal qp_OK. The control signal 110 can be a 5-bit bus signal configured to instruct controller 101 to increase or decrease the period of the clock signal CLK. For example, the control signal 110 can be a binary 5-bit signal equal to 00000, which represents the shortest period of the clock signal CLK. Conversely, the control signal 110 can be a binary 5-bit signal equal to 11111, which represents the longest period of the clock signal CLK or the control signal 110 can be a value between 00000 and 11111.

Depending on the value of the signal qp_OK, the clock controller 107 can count up or down incrementally and output the corresponding value as control signal 110. For example, if the sampled voltage 108 is below the lower bound of the voltage window, the qp_OK signal received by clock controller 107 would indicate a LOW signal. In response, the clock controller 107 would decrease the counter value by one, such as from 10001 to 10000, and output this updated control signal 110. This would instruct controller 101 to slightly increase the clock frequency (equivalently decreasing the period of CLK). If the control signal 110 is already 00000 then it cannot decrement any further.

In the next clock cycle, the clock controller 107 can determine whether the sampled voltage 108 is now within the voltage window. If the signal remains out of the voltage window, the clock controller 107 decrements the counter by one again, outputting a slightly higher frequency (shorter period) than the previous cycle. This process continues until the sampled voltage 108 falls within the voltage window, at which point the qp_OK signal transitions to HIGH.

When qp_OK indicates a HIGH signal, the clock controller 107 knows that the sampled voltage 108 is now within the window. It can then begin decreasing the clock frequency by counting up the counter value, reducing the frequency of CLK incrementally with each clock cycle or after skipping many clock cycles. If the counter value is 11111, then it cannot increment any further. The signal SELECT, input to controller 101, can also be provided to the clock controller 107. Anytime the signal SELECT changes, it can reset the counter value of clock controller 107 to its lowest count, 00000, which corresponds to the shortest period of the clock signal CLK. This causes the controller 101 to drive the charge pump 103 at its highest frequency, even before the iterative process of walking the period down has had a chance to begin. This acts as a reset mechanism for the clock controller 107.

The adjustment of the CLK period by controller 101 can be implemented in multiple ways. For example, the period of the clock signal CLK can be increased/decreased linearly per each sensing cycle. In another example embodiment, the period of the clock signal CLK can be increased/decreased non-linearly per each sensing cycle. If the output voltage Vout−Vsrc remains in the output voltage window, the clock signal CLK period can continue increasing until reaching the maximum period length of the clock signal CLK. If the output voltage is detected to be outside the output voltage window, the clock signal CLK period will be decreased.

Depending on the configuration of the load 111, the output voltage characteristics could vary. For example, if the load is purely capacitive, the output voltage will asymptotically settle at the steady state voltage of charge pump 103. If the load 111 comprises of a non-capacitive load (e.g., resistive load connected in parallel to the capacitor C_{load}), the output voltage will regulate around the lower bound of the voltage window.

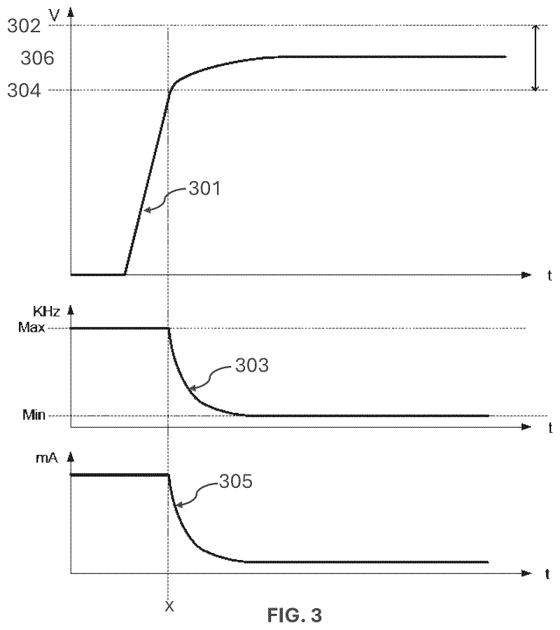

FIG. 3 is a diagram showing the waveforms of the implementation of a charge pump with adaptive period shifting in another embodiment. Descriptions of FIG. 3 may reference components shown in FIG. 1 and FIG. 2. In FIG. 3, three waveforms are illustrated. Waveform 301 represents the output voltage Vout−Vsrc of charge pump 103, illustrating the voltage change (V) over time (t). Waveform 303 represents the frequency of the clock signal CLK, illustrating the frequency change (KHz) over time (t). Waveform 305 represents the bias current of the charge pump, illustrating the bias current change (mA) over time (t).

As described in the example embodiments above, when SELECT signals enables the operation of the charge pump 103, the charge pump 103 operates at the maximum frequency. Waveform 303 illustrates this where the waveform is at its maximum at the start. At its maximum frequency, the output voltage (waveform 301) begins to rise toward its steady state voltage as depicted by line 306. Lines 302 and 304 represent the upper bound voltage and lower bound voltage of the voltage window defined by window detection circuit 105, respectively. At a time X, output voltage Vout−Vsrc (waveform 301) intersects into the lower bound of the voltage window as shown by waveform 301. At this time, the clock controller 107 begins to instruct controller 101 to decrease the frequency of the clock signal CLK as illustrated by waveform 303 stepping down cycle by cycle or after skipping many clock cycles until reaching the minimum frequency. Due to the decrease in frequency, the current bias begins to decrease as well, as illustrated by waveform 305 at time X.

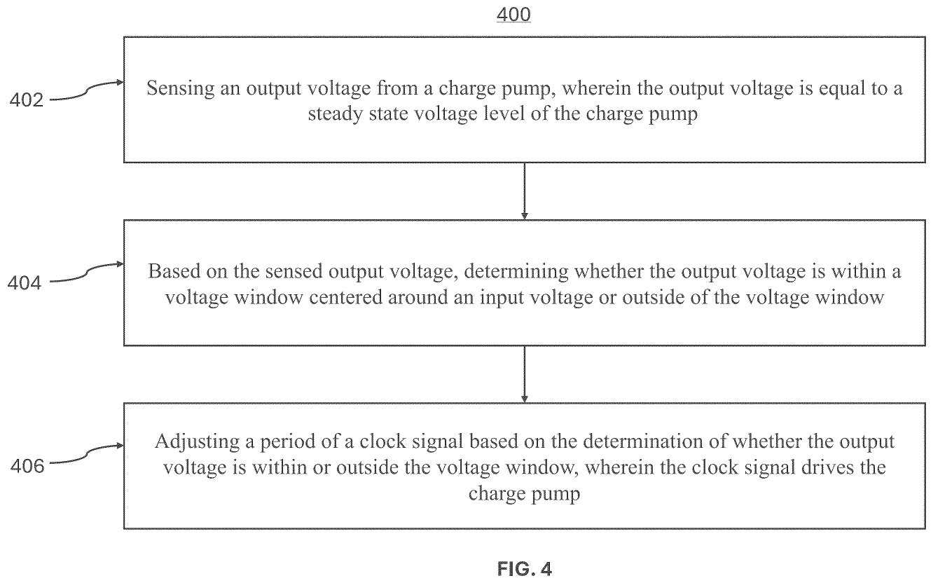

FIG. 4 is a flow chart illustrating a process to implement a charge pump with adaptive period shifting in an example embodiment. A process 400 can include one or more operations, actions, or functions as illustrated by one or more of blocks 402, 404, and/or 406. Although illustrated as discrete blocks, various blocks can be divided into additional blocks, combined into fewer blocks, eliminated, performed in different order, or performed in parallel, depending on the desired implementation.

Process 400 can be performed by a charge pump. Process 400 can begin at block 402, where the controller can sense an output voltage from a charge pump. The output voltage is equal to a steady state voltage level of the charge pump. The process can continue from block 402 to block 404. At block 404, based on the sensed output voltage, the controller can determine whether the output voltage is within a voltage window centered around an input voltage or outside of the voltage window. The process can continue from block 404 to block 406. At block 406, the controller can adjust a period of a clock signal based on the determination of whether the output voltage is within or outside the voltage window, wherein the clock signal drives the charge pump.

In another embodiment, the charge pump can further increase the period of the clock signal when the signal indicates the output voltage is within the voltage window. In another embodiment, the charge pump can further decrease the period of the clock signal when the signal indicates the output voltage is outside the voltage window. In another embodiment, the charge pump can further sense the output voltage periodically and adjusting the period of the clock signal periodically.

In another embodiment, wherein when an operation mode of the charge pump changes, the charge pump can further minimize the period of the clock signal. In another embodiment, the voltage window is bound by an upper threshold that is greater than the steady state voltage level and a lower bound threshold that is less than the steady state voltage level. In another embodiment, a first difference between the upper threshold and the steady state voltage level and a second difference between the lower threshold and the steady state voltage level are unequal.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### EXAMPLES

Example 1: A semiconductor device comprising: a voltage sense circuit configured to sense an output voltage from a charge pump, wherein the output voltage is equal to a steady state voltage level of the charge pump; a circuit configured to output a signal that indicates whether the sensed output voltage is within a voltage window centered around an input voltage or outside of the voltage window; and a controller configured to adjust a period of a clock signal based on the signal output by the circuit, wherein the clock signal drives the charge pump.

Example 2: The semiconductor device of example 1, wherein the controller is further configured to increase the period of the clock signal when the signal indicates the output voltage is within the voltage window.

Example 3: The semiconductor device of any one of example 1 to 2, wherein the controller is further configured to decrease the period of the clock signal when the signal indicates the output voltage is outside the voltage window.

Example 4: The semiconductor device of any one of example 1 to 3, wherein the voltage sense circuit is configured to sense the output voltage periodically and the controller is configured to adjust the period of the clock signal periodically.

Example 5: The semiconductor device of any one of example 1 to 4, wherein when an operation mode of the charge pump changes, the controller is configured to minimize the period of the clock signal.

Example 6: The semiconductor device of any one of example 1 to 5, wherein the voltage window is bound by an upper threshold that is greater than the steady state voltage level and a lower bound threshold that is less than the steady state voltage level.

Example 7: A system comprising a charge pump configured to convert an input voltage into an output voltage equal to a steady state level of the charge pump; a controller configured to generate a clock signal to drive the charge pump; and a circuit configured to: sense the output voltage being outputted by the charge pump; based on the sensed output voltage, determine whether the output voltage is within a voltage window centered around the input voltage or outside of the voltage window; and adjust a period of the clock signal based on the determination of whether the output voltage is within the voltage window or outside of the voltage window.

Example 8: The system of example 7, wherein the circuit is further configured to increase the period of the clock signal when the signal indicates the output voltage is within the voltage window.

Example 9: The system of any one of example 7 to 8, wherein the circuit is further configured to decrease the period of the clock signal when the signal indicates the output voltage is outside the voltage window.

Example 10: The system of any one of example 7 to 9, wherein the circuit is configured to: sense the output voltage periodically; and adjust the period of the clock signal periodically.

Example 11: The system of any one of example 7 to 10, wherein: the controller is configured to generate a select signal to control an operation mode of the charge pump; in a first operation mode, the charge pump increases the input voltage to reach the steady state voltage level; and in a second operation mode, the charge pump decreases the input voltage to reach the steady state voltage level.

Example 12: The system of any one of example 7 to 11, wherein when an operation mode of the charge pump changes, the circuit is configured to minimize the period of the clock signal.

Example 13: The system of any one of example 7 to 12, wherein the voltage window is bound by an upper threshold that is greater than the steady state voltage level and a lower bound threshold that is less than the steady state voltage level.

Example 14: A method comprising: sensing an output voltage from a charge pump, wherein the output voltage is equal to a steady state voltage level of the charge pump; based on the sensed output voltage, determining whether the output voltage is within a voltage window centered around an input voltage or outside of the voltage window; and adjusting a period of a clock signal based on the determination of whether the output voltage is within or outside the voltage window, wherein the clock signal drives the charge pump.

Example 15: The method of example 14, further comprising increasing the period of the clock signal when the signal indicates the output voltage is within the voltage window.

Example 16: The method of any one of example 14 to 15, further comprising decreasing the period of the clock signal when the signal indicates the output voltage is outside the voltage window.

Example 17: The method of any one of example 14 to 16, further comprising sensing the output voltage periodically and adjusting the period of the clock signal periodically.

Example 18: The method of any one of example 14 to 17, wherein when an operation mode of the charge pump changes, the method further comprises minimizing the period of the clock signal.

Example 19: The method of any one of example 14, to 18 wherein the voltage window is bound by an upper threshold that is greater than the steady state voltage level and a lower bound threshold that is less than the steady state voltage level.

Example 20: The method of any one of example 14 to 19, wherein a first difference between the upper threshold and the steady state voltage level and a second difference between the lower threshold and the steady state voltage level are unequal

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the present disclosure in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. A semiconductor device comprising:
a voltage sense circuit configured to sense an output voltage from a charge pump, wherein the output voltage is equal to a steady state voltage level of the charge pump;
a circuit configured to output a signal that indicates whether the sensed output voltage is within a voltage window centered around an input voltage or outside of the voltage window; and
a controller configured to adjust a period of a clock signal based on the signal output by the circuit, wherein the clock signal drives the charge pump.

2. The semiconductor device of claim 1, wherein the controller is further configured to increase the period of the clock signal when the signal indicates the output voltage is within the voltage window.

3. The semiconductor device of claim 1, wherein the controller is further configured to decrease the period of the clock signal when the signal indicates the output voltage is outside the voltage window.

4. The semiconductor device of claim 1, wherein the voltage sense circuit is configured to sense the output voltage periodically and the controller is configured to adjust the period of the clock signal periodically.

5. The semiconductor device of claim 1, wherein when an operation mode of the charge pump changes, the controller is configured to minimize the period of the clock signal.

6. The semiconductor device of claim 1, wherein the voltage window is bound by an upper threshold that is greater than the steady state voltage level and a lower bound threshold that is less than the steady state voltage level.

7. A system comprising:
a charge pump configured to convert an input voltage into an output voltage equal to a steady state level of the charge pump;
a controller configured to generate a clock signal to drive the charge pump; and
a circuit configured to:
sense the output voltage being outputted by the charge pump;
based on the sensed output voltage, determine whether the output voltage is within a voltage window centered around the input voltage or outside of the voltage window; and
adjust a period of the clock signal based on the determination of whether the output voltage is within the voltage window or outside of the voltage window.

8. The system of claim 7, wherein the circuit is further configured to increase the period of the clock signal when the signal indicates the output voltage is within the voltage window.

9. The system of claim 7, wherein the circuit is further configured to decrease the period of the clock signal when the signal indicates the output voltage is outside the voltage window.

10. The system of claim 7, wherein the circuit is configured to:
sense the output voltage periodically; and
adjust the period of the clock signal periodically.

11. The system of claim 7, wherein:
the controller is configured to generate a select signal to control an operation mode of the charge pump;
in a first operation mode, the charge pump increases the input voltage to reach the steady state voltage level; and
in a second operation mode, the charge pump decreases the input voltage to reach the steady state voltage level.

12. The system of claim 7, wherein when an operation mode of the charge pump changes, the circuit is configured to minimize the period of the clock signal.

13. The system of claim 7, wherein the voltage window is bound by an upper threshold that is greater than the steady state voltage level and a lower bound threshold that is less than the steady state voltage level.

14. A method comprising:
sensing an output voltage from a charge pump, wherein the output voltage is equal to a steady state voltage level of the charge pump;
based on the sensed output voltage, determining whether the output voltage is within a voltage window centered around an input voltage or outside of the voltage window; and
adjusting a period of a clock signal based on the determination of whether the output voltage is within or outside the voltage window, wherein the clock signal drives the charge pump.

15. The method of claim 14, further comprising increasing the period of the clock signal when the signal indicates the output voltage is within the voltage window.

16. The method of claim 14, further comprising decreasing the period of the clock signal when the signal indicates the output voltage is outside the voltage window.

17. The method of claim 14, further comprising sensing the output voltage periodically and adjusting the period of the clock signal periodically.

18. The method of claim 14, wherein when an operation mode of the charge pump changes, the method further comprises minimizing the period of the clock signal.

19. The method of claim 14, wherein the voltage window is bound by an upper threshold that is greater than the steady state voltage level and a lower bound threshold that is less than the steady state voltage level.

20. The method of claim 19, wherein a first difference between the upper threshold and the steady state voltage level and a second difference between the lower threshold and the steady state voltage level are unequal.
